(19) United States
(12) Patent Application Publication
(10) Pub. No.: US 2007/0055522 A1
(43) Pub. Date: Mar. 8, 2007

(54) Self-learning multi-source speech data reconstruction

(75) Inventor: Ngai Chiu Wong, San Ramon, CA (US)

Correspondence Address: GREENBLUM & BERNSTEIN, P.L.C., 1950 ROLAND CLARKE PLACE, RESTON, VA, 20191, US

(73) Assignee: SBC Knowledge Ventures, L.P., Reno, NV (US)

(21) Appl. No.: 11/211,640

(22) Filed: Aug. 26, 2005

(51) Int. Cl. G10L 15/18

(52) U.S. Cl. 704/257

(57) ABSTRACT

A method integrates data from disparate speech recognition system data sources. The method includes receiving data from disparate speech recognition system data sources including a first speech recognition system data source and a second speech recognition system data source. The method also includes discovering rules that relate the data from the first speech recognition system data source to the data from the second speech recognition system data source. The method further includes integrating the data from the first speech recognition system data source and the data from the second speech recognition system data source based upon the discovered rules.

### BACKGROUND OF THE INVENTION

1. Field of the Invention

The present invention relates to speech data reconstruction, and more particularly to a self-learning multi-source speech data reconstruction system.

2. Background Information

A conventional speech recognition system combines best-of-breed components from different vendors. For example, the Southwestern Bell Communications (SBC) HR One Stop speech system includes 1) telephony, 2) a speech recognition engine, 3) a text-to-speech engine, 4) a CTI (computer telephony integration) provider, 5) application servers, and 6) enterprise resource planning (ERP)/backend database systems. The different components are from different vendors. Additionally, the different components run on different machines.

Adequate integration does not exist for the different components of a conventional speech recognition system. For example, the speech recognition engine may not be aware of the application flow and telephony events, while an application server does not know the speech recognition and CTI details.

Due to the lack of integration, a complete analysis of the operations of a speech recognition system requires records of events for each of the different components. Thus, an integrated system is needed for combining information from the various engines for system administration and problem management.

The speech industry market place does not offer systems for integration of unstructured data across vendor platforms and engines. Accordingly, troubleshooting, analysis and design often requires days or weeks of manual data review of the many data sources.

Currently, the common simple network management planning (SNMP) framework and traditional data mining can be used with data warehouses. However, the simple network management planning framework lacks intelligence to compress or combine information. Further, the only reliable data mining method provided by a professional data warehouse is structured data mining, which is not a method of mining structured data from multiple data sources. Rather, structured data mining merely used mining parameters that are more rigid than those used in unstructured data mining. Thus, structured data mining does not convert and compress unstructured data into structured data that can be mined.

Accordingly, a need exists to integrate and structure data from multiple speech recognition system data sources. Further, a need exists to determine rules that relate the data from the different sources. Additionally, a need exists to apply the determined rules to the data from the different sources.

To solve the above-described problems, a system is provided for self-learning multi-source speech data reconstruction.

### BRIEF DESCRIPTION OF THE DRAWINGS

FIG. 1 shows exemplary application components used for self-learning multi-source speech data reconstruction;

FIG. 2 shows an exemplary reconstruction mechanism implemented by a speech data reconstructor;

FIG. 3 shows an exemplary method for integrating data from speech recognition system data sources;

FIG. 4 shows an exemplary process of applying rules in a method for integrating data from speech recognition system data sources;

FIG. 5 shows an exemplary process of scoring the reliability of grouped logs in a method for integrating data from speech recognition system data sources; and

FIG. 6 shows an exemplary general computer system that includes a set of instructions for performing a method of self-learning multi-source speech data reconstruction.

### DETAILED DESCRIPTION

In view of the foregoing, the present invention, through one or more of its various aspects, embodiments and/or specific features or sub-components, is thus intended to bring out one or more of the advantages as specifically noted below.

According to an aspect of the present invention, a method is provided for integrating data from speech recognition system data sources. The method includes receiving data from disparate speech recognition system data sources. The disparate speech recognition data sources include a first speech recognition system data source and a second speech recognition system data source. The method also includes discovering rules that relate the data from the first speech recognition system data source to the data from the second speech recognition system data source. The method further includes integrating the data from the first speech recognition system data source and the data from the second speech recognition system data source based upon the discovered rules.

According to another aspect of the present invention, the integrating includes applying the discovered rules to the data from the first speech recognition system data source and the data from the second speech recognition system data source by matching related data from the first speech recognition system data source and the second speech recognition system data source according to the discovered rules.

According to yet another aspect of the present invention, the applying further includes eliminating redundancies in the data received from the first speech recognition system data source and the second speech recognition system data source. The applying also includes presenting data from the first speech recognition system data source and the second speech recognition system data source as a single event.

According to still another aspect of the present invention, a rule is determined based on a common identifier of an event recorded in a log of the first speech recognition system data source and a log of the second speech recognition system data source.

According to another aspect of the present invention, a rule is determined based on time proximity between receipt of data from the first speech recognition system data source and the data from the second speech recognition system data source.

According to yet another aspect of the present invention, the method also includes proposing a discovered rule to a user of the first speech recognition system data source and the second speech recognition system data source before applying the discovered rule to the data received from the first speech recognition system data source and the second speech recognition system data source.

According to still another aspect of the present invention, the method includes grouping a log from the first speech recognition system data source and a log from the second speech recognition system data source according to a call. The method further includes creating a call specific summary for the grouped logs.

According to another aspect of the present invention, the method includes scoring reliability of grouped logs by determining whether expected data is missing. The reliability score is lowered when expected data is missing.

According to yet another aspect of the present invention, the method includes creating a new rule when data from the first speech recognition system data source and the data from the second speech recognition system data source contradict an existing rule. The method also includes applying the new rule to the data from the first speech recognition system data source and the data from the second speech recognition system data source.

According to still another aspect of the present invention, the method includes determining whether a preestablished rule is applicable to the data from the first speech recognition system data source and the data from the second speech recognition system data source. The method also includes applying the preestablished rule to the data from the first speech recognition system data source and the data from the second speech recognition system data source when the preestablished rule is determined to be applicable to the data from the first speech recognition system data source and the data from the second speech recognition system data source.

According to an aspect of the present invention, a computer readable medium stores a computer program that applies automatic matching and reconstruction mechanisms for speech application data. The computer readable medium includes a data receiving code segment that receives data from disparate speech recognition system data sources comprising a first speech recognition system data source and a second speech recognition system data source. The computer readable medium also includes a rule discovering code segment that discovers rules that relate the data from the first speech recognition system data source to the data from the second speech recognition system data source. The computer readable medium further includes an integrating code segment that integrates the data from the first speech recognition system data source and the second speech recognition system data source based upon the discovered rules.

According to another aspect of the present invention, the integrating code segment includes a rule applying code segment that applies the discovered rules to the data from the first speech recognition system data source and the data from the second speech recognition system data source by matching related data from the first speech recognition system data source and the second speech recognition system data source according to the discovered rules.

According to yet another aspect of the present invention, the rule applying code segment includes a redundancy eliminating code segment that eliminates redundancies in the data received from the first speech recognition system data source and the second speech recognition system data source. The computer readable medium also includes a data presenting code segment that presents data from the first speech recognition system data source and the second speech recognition system data source as a single event.

According to still another aspect of the present invention, a rule is determined based on a common identifier of an event recorded in a log of the first speech recognition system data source and a log of the second speech recognition system data source.

According to another aspect of the present invention, a rule is determined based on time proximity between receipt of data from the first speech recognition system data source and the data from the second speech recognition system data source.

According to still another aspect of the present invention, the computer readable medium includes a rule proposing code segment that proposes a discovered rule to a user of the first speech recognition system data source and the second speech recognition system data source before applying the discovered rule to the data received from the first speech recognition system data source and the second speech recognition system data source.

According to yet another aspect of the present invention, the computer readable medium includes a log grouping code segment that groups a log from the first speech recognition system data source and a log from the second speech recognition system data source according to a call. The computer readable medium also includes a summary creating code segment that creates a call specific summary for the grouped logs.

According to another aspect of the present invention, the computer readable medium includes a reliability scoring code segment that scores the reliability of grouped logs by determining whether expected data is missing. The reliability score is lowered when expected data is missing.

According to still another aspect of the present invention, the computer readable medium includes a new rule creating code segment that creates a new rule when data from the first speech recognition system data source and the data from the second speech recognition system data source contradicts an existing rule. The computer readable medium also includes a rule applying code segment that applies the new rule to the data from the first speech recognition system data source and the data from the second speech recognition system data source.

According to yet another aspect of the present invention, the computer readable medium also includes a rule determining code segment that determines whether a preestablished rule is applicable to the data from the first speech recognition system data source and the data from the second speech recognition system data source. The computer readable medium further includes a preestablished rule applying code segment that applies the preestablished rule to the data from the first speech recognition system data source and the data from the second speech recognition system data source when the preestablished rule is determined to be applicable to the data from the first speech recognition system data source and the data from the second speech recognition system data source.

The present invention addresses how to convert and compress unstructured data into structured data that can be mined. Information from multiple sources of speech recognition domain data is integrated using reconstruction mechanisms of a self-learning multi-source speech data reconstruction system. The architecture may allow for self discovery and learning, such that technicians do not need to manually learn or understand new dynamics, behaviors and messages for software upgrades or when new engines/components are introduced.

A linkage engine receives data from multiple data sources and then attempts to match up related data using predetermined guiding principles, such as time proximity and common identifiers. The linkage engine outputs reconstruction hypotheses, which are a collection of relevant events or information clusters. A reconstructor takes in the reconstruction hypotheses and matches them up against applicable rules in a reconstruction rule book. The reconstructor outputs an integrated log, which is a group summary of logs from the multiple data sources. An integrated log aids in trouble-shooting and assists in finding patterns leading up to system failures. For example, in a speech application, a call is a key unit of analysis. Logs can be grouped according to calls and a call specific summary is created. If multiple groups are defined, multiple summaries are created.

The reconstructor also outputs integrated data corresponding to the data from the data sources. The integrated data is data from the multiple data sources that is converted and compressed. The integrated data is easily mined though the data is from multiple different data sources. The integrated data structure can be expressed as both thin and wide. The data structure is thin in the sense that only key events are highlighted. Even when multiple data sources signal different symptoms for a particular event, only one event is recorded. The data structure is wide in the sense that all information associated with an event is packed into the single event. Therefore, a single row may include many columns. Since one system event does not usually involve all data sources, the data density is low, with a moderate ratio of empty fields. For readability, the database is designed to have primary, secondary and tertiary information columns which display the most important, sensible data fields for the user. For a caller initiated event, the primary/secondary information field might be the active grammar/user response from the speech recognition engine, but for enterprise resource planning request events, the primary/secondary information field might be the function call name/error code.

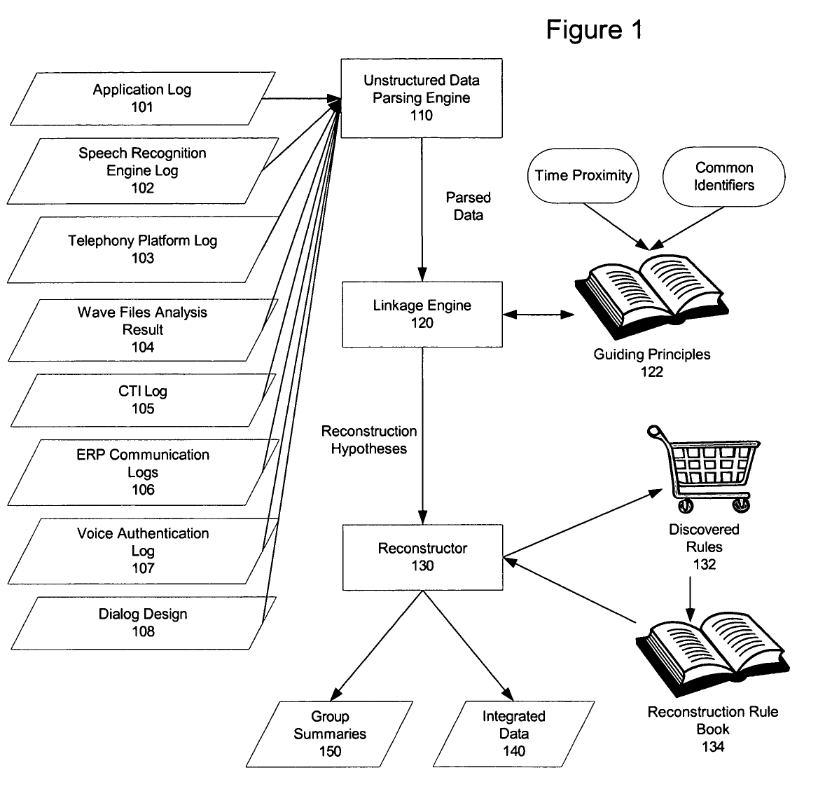

FIG. 1 shows exemplary application components used to apply self-learning multi-source speech data reconstruction. Information and data from various speech system components is provided to an unstructured data parsing engine 110. In the embodiment shown in FIG. 1, the speech system information which is provided as input to the unstructured data parsing engine 110 includes an application log 101, a speech recognition engine log 102, a telephony platform log 103, wave files analysis results 104, a computer telephony integration log 105, an enterprise resource planning communication logs 106, a voice authentication log 107 and dialog design data 108.

The unstructured data parsing engine 110 parses the data from the speech system components which provide input, and outputs parsed data. The operation of unstructured data parsing engine 110 is similar to an SNMP framework. In other words, the unstructured data parsing engine 110 does not include intelligence to compress or combine information from the different speech system components.

The linkage engine 120 receives the data from the various speech system components via the unstructured data parsing engine 110. The linkage engine 120 attempts to match related data using predetermined guiding principles 122. Exemplary guiding principles are time proximity and common identifiers. The guiding principles are core principles that help identify rules to relate data from different speech recognition system data sources. The linkage engine 120 outputs reconstruction hypotheses, each of which is a collection of relevant events or information clusters.

Time proximity is the proximity of the time which elapses between the creation of different records for different speech recognition system data sources. Time proximity is a strong indicator that different records for events may each record the same event. For example, if a single cause exists for records recorded separately by different components of a speech recognition system, the events are likely to be recorded in a small time frame such that time proximity can be used to indicate that the events are related. In one embodiment, events occurring within hundreds of milliseconds of each other are grouped and then presented as a single event with integrated details and without redundant information.

Records logged by different components of a speech recognition system may include identifiers which identify the events which are the subject of the records. Common identifiers are a strong indicator that different records for events may each record the same event. For example, if a single cause exists for different components to record the event separately, the events are likely to be recorded by the different components of the speech recognition system using the same terminology.

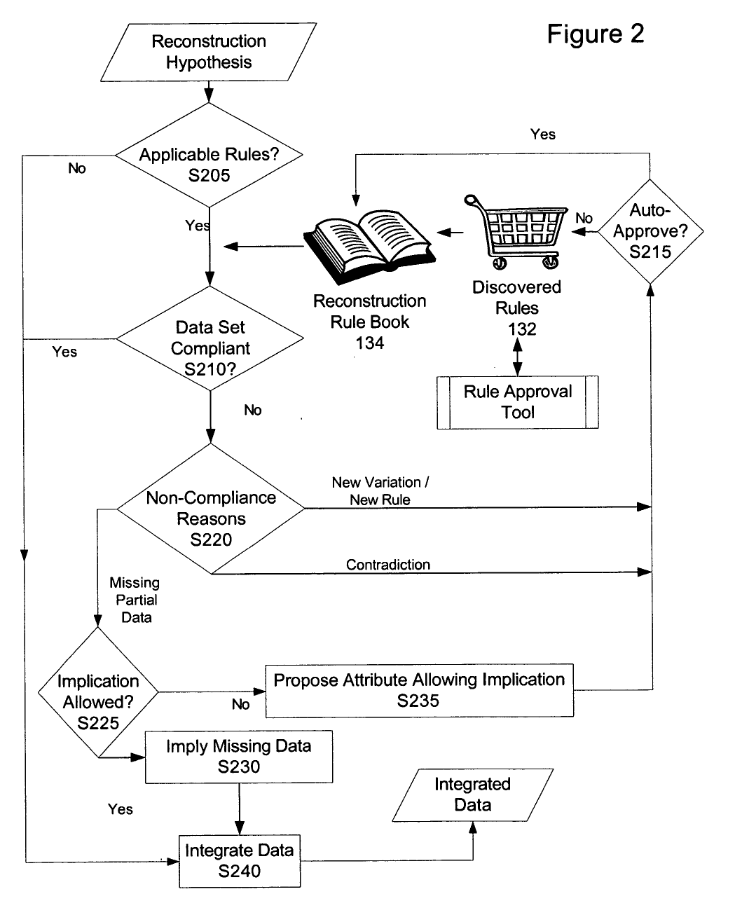

The reconstruction hypotheses that are output from the linkage engine 12 are input to a reconstructor 13 and matched with applicable rules in a reconstruction rule book 134. An exemplary reconstruction process implemented by the reconstructor 13 is shown in FIG. 2.

As described above, a linkage engine 12 receives data from a wide spectrum of data sources 101-108 and then makes a first attempt at matching related data, using guiding principles 122.

The reconstruction rules use pattern matching to look for specific patterns of data. As an example, if a speech recognition engine goes out of service at approximately the same time as a telephony platform, a rule might be determined to exist where one such outage is the result of the other. In such a case, the discovered rule could be structured as “if X, then Y”, where X and Y are both outages, and where X is the outage that is determined to cause the outage Y. A rule may also be determined as “Y only if X”, where outage X is determined to be the only outage that causes Y. The rules are determined by analyzing the data in view of the guiding principles 122 to form reconstruction hypotheses. Once determined, rules in a reconstruction rule book 134 can be used to correct problems in the operation of the various speech system components. In the above example, the rules can be used in mining the structured data to discover and remedy system failures by linking one outage (Y to another (X in a causal relationship.

As another example, some speech recognition system components are used to provide interactive voice response services over a telecommunications network. In the interactive voice response environment, a user may be prompted to navigate through an interactive script by answering questions vocally and/or by providing dual tone multi-frequency answers using a telephone keypad. The interactive voice response service follows a script, where only a limited set of answers are tolerated or expected at particular points. In such an environment, a user may be prompted at a particular point to say “yes” to confirm and finalize a transaction. Accordingly, when a speech pattern for the word “yes” is output from the speech recognition engine at approximately the same time as a transaction is initiated at an enterprise resource management component, a rule might be determined to exist where one closely follows the other. The rule may be determined as “if X at point A, then Y”, where X is a particular speech pattern from the speech recognition engine at point A during the script and where Y is the initiation of a transaction by an enterprise resource management component. In the above example, the rule can be used in mining the structured data to discover and remedy system failures by linking the receipt of a speech pattern X at point A (by a speech recognition engine with the initiation of a transaction Y (by an enterprise resource management component).

As shown in FIG. 1, the reconstructor 130 relies on a reconstruction rule book 134 of existing reconstruction rules. The rules in the reconstruction rule book 134 may initially be rules provided by a software developer that implements the self-learning multi-source speech data reconstruction. Alternatively, the rules in the reconstruction rule book 134 may initially be rules customized by a system user or administrator.

As explained below, the reconstructor 130 also discovers rules on a continuing basis, based on relationships among the parsed data from the various speech system components. The discovered rules are associated with a discovered rule basket 132. The system may either automatically implement discovered rules, or wait for manual approval of the discovered rules by a user or administrator.

The reconstructor 130outputs integrated data 140and group summaries 150. A group summary 140 is a call-specific summary of a group of logs related to a call. Integrated data 150 is data which has been reconstructed by applying the rules from the reconstruction rule book 134 to data from different components of a speech recognition system. As explained herein, the rules in the reconstruction rule book 134 are used to link data from the different data sources. When the data of different events is combined using the rules in the reconstruction rule book 134, a single call-specific summary 150 summarizes the information of what had previously been recorded as multiple different events. Additionally, when the data of different events is combined using the rules of the reconstruction rule book 134, the data of the multiple different events is presented as integrated data 140 of a single event.

The rules in the reconstruction rule book 134 can also be fed back for use as guiding principles by the linkage engine 120. In contrast to general guiding principles such as time proximity and common identifiers, rules in the reconstruction rule book 134 are likely to be specifically tailored to particular data from particular sources. Nevertheless, the rules may be used by the linkage engine 120 to ensure that related event data from different sources is properly grouped and linked. As an example, a rule might recognize data from a speech recognition engine as a “recognition” event and coinciding data from a telephony component as an “exception” event. The exemplary rule would then link the two events together for combination, e.g., if they occur within a predetermined amount of time of each other. Thus, the reconstruction rules can be used as domain-specific guiding principles 122 to ensure that related event data from different sources is properly grouped and linked.

FIG. 2 shows an exemplary reconstruction mechanism implemented by a speech data reconstructor. Starting with an input reconstruction hypothesis, a reconstructor determines whether any applicable rules exist at S205. The reconstructor determines whether the reconstruction hypothesis includes a proposed link of data from different sources as determined using the guiding principles. The reconstructor may also refer to the existing reconstruction rulebook 134 to determine if rules in the reconstruction rulebook 134 are expected to apply to the data from the different sources. If applicable rules exist (S205=Yes), a determination is made whether the input data set completely matches the rule definitions at S210. If no applicable rules exist (S205=No), or if the data set completely matches the rule definitions at S210 (S210=Yes), the data is integrated at S240 and the process ends.

If the data set does not completely match the rule definitions (S210=No), a determination of non-compliance reasons is made at S220. If the data set is non-compliant because an as-yet unapproved new variation or new rule has been proposed as part of the reconstruction hypothesis based on the guiding principles, a determination is made at S215 whether the new variation or new rule should be auto-approved. Similarly, if the data set is non-compliant because it contradicts an existing rule, a determination is made whether a waiver of the existing rule should be auto-approved at S215. Thus, if a rule exists that “if X then only Y”, but the data set includes X and Z, the data set is non-compliant because it contradicts an existing rule. Thus, a determination must be made whether the existing rule can be waived for the current data set. In another embodiment, a determination is made whether a second rule provides an exception to a first rule.

If the data set is non-compliant because it is missing partial data, a determination is made whether a rule allows for implication of missing data at S225. Thus, if a rule exists that “if X then Y”, but the data set includes X and not Y, the data set is non-compliant because it is missing Y. If the rule does not allow for implication (S225=No), an attribute is proposed which would allow implication at S235. The proposed attribute would allow an implication of Y when X exists, and may depend on other data that is present in the set of data from the multiple sources. For example, a proposed attribute may be “if X and Z, then imply Y if Y is not present”. The proposed attribute would be supplemental to a primary rule of, e.g., “if X then Y”.

A determination is made at S225 whether the proposed attribute should be auto-approved. If the rule allows for implication (S225=Yes), the missing data is implied at S230, the data is integrated at S240 and the process ends.

When any proposed new variation, new rule, new attribute, or new exception to an existing rule is not auto-approved (S215=No), the proposal is forwarded to a discovered rules basket 132. Proposals in the discovered rules basket 132 are subject to approval by a user of the speech reconstruction system using a rule approval tool. Approved variations, rules, attributes and exceptions from the discovered rules basket 132 are entered into the reconstruction rule book 134. Additionally, when any proposed new variation, new rule, new attribute or new exception to an existing rule is auto-approved (S215=Yes), the new variation, rule, attribute or exception is entered into the reconstruction rule book 134. After new variations, rules, attributes and exceptions are entered into the reconstruction rule book 134, the process returns to S210 and the determination is again made whether the input data set complies with the rule definitions at S210.

Although FIG. 2 shows that the rules are immediately applied to a data set under consideration, the reconstruction rules can also be used later to construct hypotheses. Thus, the decision at S205 may be based upon rules from the reconstruction rule book 134 that are used in the reconstruction hypothesis under examination.

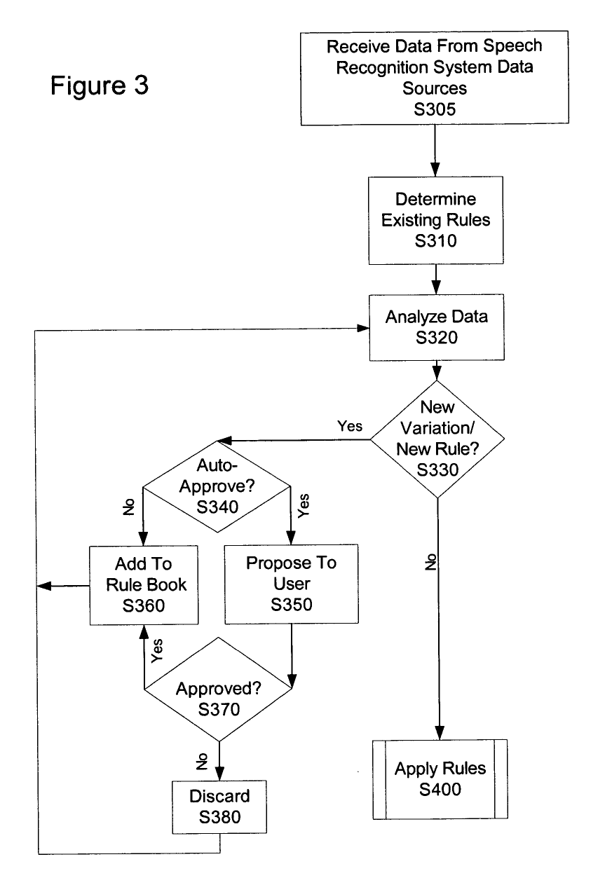

FIG. 3 shows an exemplary method for integrating data from speech recognition system data sources. At S305, data is received from different speech recognition system data sources. At S310, rules from the reconstruction rulebook 134 are retrieved. At S320, the data received at S305 is analyzed according to the rules from the reconstruction rulebook 134. At S330, a determination is made whether a new variation or a new rule should be recorded based on the analysis of the data at S320. If a new variation or new rule should be created (S330=Yes), a determination is made at S340 whether new variations or new rules are automatically approved. If new variations or new rules are automatically approved (S340=Yes), the new variation or new rule is added to the reconstruction rulebook 134 at S360. If new variations or new rules are not automatically approved (S340=No), the new variation or new rule is proposed to a user at S350 from the discovered rules basket 132. After proposing the new variation or new rule to the user at S350, a determination is made at S370 whether the new variation or new rule has been approved. If the new variation or new rule is approved (S370=Yes), the new variation or new rule is added to the rulebook 134 at S360. If the new variation or new rule is not approved (S370=No), the new variation or new rule is discarded at S380.

After adding a new variation or new rule to the rulebook 134 at S360, or after discarding a new variation or new rule at S380, the process returns to S320 and the data is analyzed again in view of the newly discovered rules. When no new variations or new rules are determined at S330, the rules are applied in a process at S400.

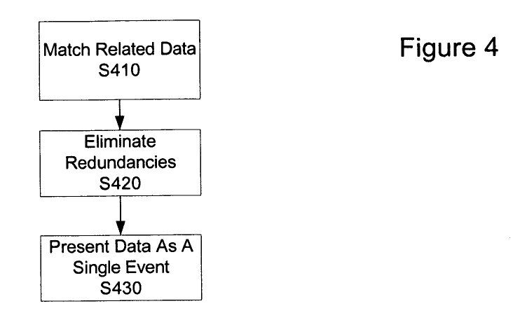

FIG. 4 shows an exemplary process of applying rules in a method for integrating data from speech recognition system data sources. At S410, related data is matched. Redundancies are eliminated at S420, and related events are presented as a single event at S430.

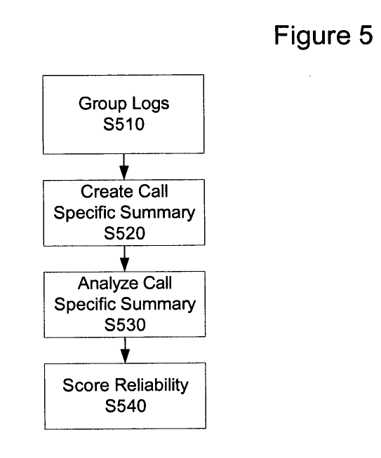

FIG. 5 shows an exemplary process of scoring the reliability of grouped logs in a method for integrating data from speech recognition system data sources. At S510, data of logs from different components of a speech reconstruction system is grouped using the guiding principles 122. As an example, if events are generated from two separate components within a very short or overlapping period of time, the data of the logs of the different components may be grouped. A call-specific summary is created for the grouped logs at S520. The call specific summary is analyzed at S530, and the reliability of the call specific summary is scored at S540 to determine the trustworthiness of the process and determined rules. The reliability of the call specific summary may be determined by ascertaining the number and importance of approved exceptions and waivers of specified rules. The reliability of the call specific summary may also be determined by ascertaining the amount and importance of data that was implied at S230.

A reliability score can be used as a metric to rate a grouping summary. If missing data is discovered during the reconstruction process, then the score is lowered by the weight of the rule. If data contradicts a solid (unbreakable) rule, the score may be set to zero. Other non-solid rules may significantly reduce the score. When running a history report on the integrated data, data with higher reliability can be filtered and accepted, whereas an entire grouping may be discarded if the score is low.

A trustworthy call-specific summary is an integrated log that accurately summarizes related events recorded by the different components of a speech reconstruction system, and that presents the related events as single event. The integrated log aids trouble-shooting and helps an administrator find patterns leading up to system failures. In addition to integrating various data, self-learning multi-source speech data reconstruction can be used to reduce the amount of data which must be parsed in a data-mining operation. Data mining operations consistently face the problem of being presented with too much data. Self-learning multi-source speech data reconstruction combines redundant information without losing important details.

As described above, the data reconstruction process is a semi-automated process. The automatic linkage engine 120 uses guiding principles 122, such as time proximity and unique interaction identifiers, to link data. The semi-automatic portion allows users to control the data reconstruction process with manually entered or manually approved rules, while also allowing the engine to “discover” new rules.

The engine can be configured to automatically apply discovered rules, or mark them as unapproved rules. Users can manually select which rules to accept and apply from a discovered rules basket 132, using a rule approval tool.

The architecture also compensates for unreliable data. Not all data sources are reliable. For example, a rule R might hold that when engine A registers event X, engine B should experience f(X). The ideal reconstruction scenario is that data from engine A contains X, and the data from engine B contains the value f(X). However, in the case when engine B is missing the f(X) value because its logging has gaps, rule R will be used to reconstruct the missing f(X) value.

Central to each rule is a collection of data source/pattern specifications. When the pattern match is successful for the specifications, then a rule is applicable. All applicable rules go through the remainder of the cycle for matching the remaining specifications. If the data supplied by the hypotheses fulfill all required specifications, but do not fully satisfy the remaining specifications, the data would be automatically generated when the missing fields allow for implication. In other non-matching cases, the rule could either be directly added to the rule book 134, or added to the discovered rule basket 132 of discovered rules, to be manually approved later. Each rule carries different weight on how the reliability score is impacted for a variety of reasons for non-compliance.

Even if the pattern specification in each rule only matches for a specific pattern in a data source, once the integration decision is made, the data associated to the matched event from that data source would be extracted and combined. As an example, if one of the specifications matches the recognition event with the pattern main_menu from the recognition logs, once matched, the data in the recognition logs would be integrated. Examples of data in a recognition log includes slot value, confidence score, duration, recognition server name and other data fields associated with the recognition event.

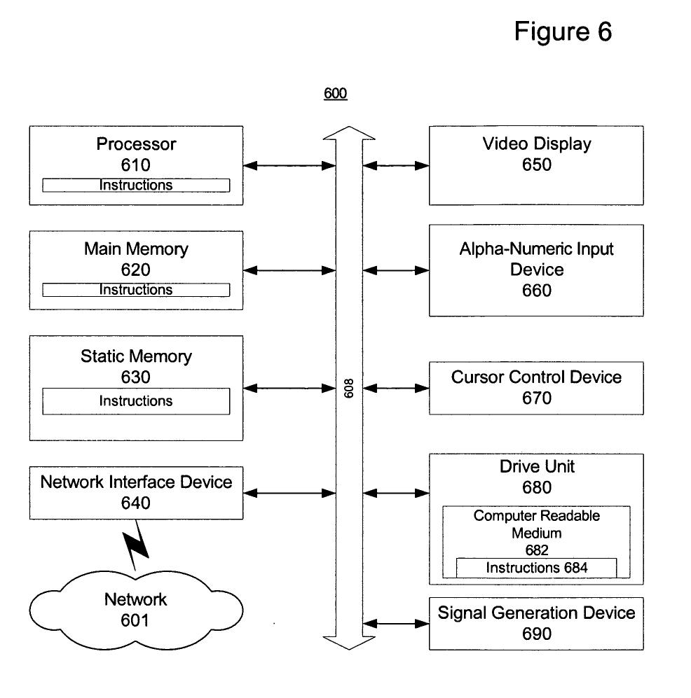

Referring to FIG. 6, an illustrative embodiment of a general computer system, on which self-learning multi-source speech data reconstruction is implemented, is shown and is designated 600. The computer system 600 can include a set of instructions that can be executed to cause the computer system 600 to perform any one or more of the methods or computer based functions disclosed herein. The computer system 600 may operate as a standalone device or may be connected, e.g., using a network 601, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 610, e.g., a central processing unit (CPU), a graphics processing unit (GPU), or both. Moreover, the computer system 600 can include a main memory 620 and a static memory 630 that can communicate with each other via a bus 608. As shown, the computer system 600 may further include a video display unit 650, such as a liquid crystal display (LCD), an organic light emitting diode (OLED), a flat panel display, a solid state display, or a cathode ray tube (CRT). Additionally, the computer system 600 may include an input device 660, such as a keyboard, and a cursor control device 670, such as a mouse. The computer system 600 can also include a disk drive unit 680, a signal generation device 690, such as a speaker or remote control, and a network interface device 640.

In a particular embodiment, as depicted in FIG. 6, the disk drive unit 680 may include a computer-readable medium 682 in which one or more sets of instructions 684, e.g. software, can be embedded. Further, the instructions 684 may embody one or more of the methods or logic as described herein. In a particular embodiment, the instructions 684 may reside completely, or at least partially, within the main memory 620, the static memory 630, and/or within the processor 610 during execution by the computer system 600. The main memory 620 and the processor 610 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 682 that includes instructions 684 or receives and executes instructions 684 responsive to a propagated signal, so that a device connected to a network 601 can communicate voice, video or data over the network 601. Further, the instructions 684 may be transmitted or received over the network 601 via the network interface device 640.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. Each of the standards, protocols and languages represent examples of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

What is claimed is:

1. A method for integrating data from speech recognition system data sources, comprising:
receiving data from disparate speech recognition system data sources comprising a first speech recognition system data source and a second speech recognition system data source;
discovering rules that relate the data from the first speech recognition system data source to the data from the second speech recognition system data source, and
integrating the data from the first speech recognition system data source and the data from the second speech recognition system data source based upon the discovered rules.

2. The method for integrating data from speech recognition system data sources of claim 1, the integrating comprising:
applying the discovered rules to the data from the first speech recognition system data source and the data from the second speech recognition system data source by matching related data from the first speech recognition system data source and the second speech recognition system data source according to the discovered rules.

3. The method for integrating data from speech recognition system data sources of claim 2, the applying further comprising:
eliminating redundancies in the data received from the first speech recognition system data source and the second speech recognition system data source, and
presenting data from the first speech recognition system data source and the second speech recognition system data source as a single event.

4. The method for integrating data from speech recognition system data sources of claim 1, wherein a rule is determined based on a common identifier of an event recorded in a log of the first speech recognition system data source and a log of the second speech recognition system data source.

5. The method for integrating data from speech recognition system data sources of claim 1, wherein a rule is determined based on time proximity between receipt of data from the first speech recognition system data source and the data from the second speech recognition system data source.

6. The method for integrating data from speech recognition system data sources of claim 1, further comprising:
proposing a discovered rule to a user of the first speech recognition system data source and the second speech recognition system data source before applying the discovered rule to the data received from the first speech recognition system data source and the second speech recognition system data source.

7. The method for integrating data from speech recognition system data sources of claim 1, further comprising:
grouping a log from the first speech recognition system data source and a log from the second speech recognition system data source according to a call; and
creating a call specific summary for the grouped logs.

8. The method for integrating data from speech recognition system data sources of claim 7, further comprising:
scoring reliability of grouped logs by determining whether expected data is missing,
wherein the reliability score is lowered when expected data is missing.

9. The method for integrating data from speech recognition system data sources of claim 1, further comprising:
creating a new rule when data from the first speech recognition system data source and the data from the second speech recognition system data source contradict an existing rule; and
applying the new rule to the data from the first speech recognition system data source and the data from the second speech recognition system data source.

10. The method for integrating data from speech recognition system data sources of claim 1, further comprising:
determining whether a preestablished rule is applicable to the data from the first speech recognition system data source and the data from the second speech recognition system data source; and
applying the preestablished rule to the data from the first speech recognition system data source and the data from the second speech recognition system data source when the preestablished rule is determined to be applicable to the data from the first speech recognition system data source and the data from the second speech recognition system data source.

11. A computer readable medium for storing a computer program that applies automatic matching and reconstruction mechanisms for speech application data, comprising:
a data receiving code segment that receives data from disparate speech recognition system data sources comprising a first speech recognition system data source and a second speech recognition system data source;
a rule discovering code segment that discovers rules that relate the data from the first speech recognition system data source to the data from the second speech recognition system data source, and
an integrating code segment that integrates the data from the first speech recognition system data source and the second speech recognition system data source based upon the discovered rules.

12. The computer readable medium of claim 11, the integrating code segment comprising:
a rule applying code segment that applies the discovered rules to the data from the first speech recognition system data source and the data from the second speech recognition system data source by matching related data from the first speech recognition system data source and the second speech recognition system data source according to the discovered rules.

13. The computer readable medium of claim 12, the rule applying code segment comprising:
a redundancy eliminating code segment that eliminates redundancies in the data received from the first speech recognition system data source and the second speech recognition system data source, and
a data presenting code segment that presents data from the first speech recognition system data source and the second speech recognition system data source as a single event.

14. The computer readable medium of claim 11, wherein a rule is determined based on a common identifier of an event recorded in a log of the first speech recognition system data source and a log of the second speech recognition system data source.

15. The computer readable medium of claim 11, wherein a rule is determined based on time proximity between receipt of data from the first speech recognition system data source and the data from the second speech recognition system data source.

16. The computer readable medium of claim 11, further comprising:
a rule proposing code segment that proposes a discovered rule to a user of the first speech recognition system data source and the second speech recognition system data source before applying the discovered rule to the data received from the first speech recognition system data source and the second speech recognition system data source.

17. The computer readable medium of claim 101, further comprising:
a log grouping code segment that groups a log from the first speech recognition system data source and a log from the second speech recognition system data source according to a call; and
a summary creating code segment that creates a call specific summary for the grouped logs.

18. The computer readable medium of claim 17, further comprising:
a reliability scoring code segment that scores the reliability of grouped logs by determining whether expected data is missing,
wherein the reliability score is lowered when expected data is missing.

19. The computer readable medium of claim 101, further comprising:
a new rule creating code segment that creates a new rule when data from the first speech recognition system data source and the data from the second speech recognition system data source contradicts an existing rule; and
a rule applying code segment that applies the new rule to the data from the first speech recognition system data source and the data from the second speech recognition system data source.

20. The computer readable medium of claim 11, further comprising:
a rule determining code segment that determines whether a preestablished rule is applicable to the data from the first speech recognition system data source and the data from the second speech recognition system data source; and
a preestablished rule applying code segment that applies the preestablished rule to the data from the first speech recognition system data source and the data from the second speech recognition system data source when the preestablished rule is determined to be applicable to the data from the first speech recognition system data source and the data from the second speech recognition system data source.
